(19) United States
(12) Patent Application Publication
(10) Pub. No.: US 2006/0219516 A1
(43) Pub. Date: Oct. 5, 2006

(54) Method and apparatus for optimizing a currency validator/dispenser

(76) Inventors: Leon Saltsov, Thornhill (CA); Vitold Khvostov, Kiev (UA); Dmytro Repetyuk, Thornhill (CA); Yuriy Rusakov, Toronto (CA); Dmytro Baydin, Toronto (CA); Mishunin Bogdan, Toronto (CA)

Correspondence Address: Dennison Associates, Suite 301, 133 Richmond Street West, Toronto, ON, M5H 2L7, CA

(21) Appl. No.: 11/098,498

(22) Filed: Apr. 5, 2005

(51) Int. Cl. G07D 7/00; G07F 7/04; G06K 9/00; G06K 7/00

(52) U.S. Cl. 194/207

(57) ABSTRACT

A banknote validator/dispenser having a plurality of banknote accumulators includes a computer control module that stores banknote receipt and dispensing transaction history information. The computer control module uses this information as part of a statistical analysis used to vary an operating procedure of the banknote validator/dispenser. In one embodiment, the operating procedure is associated with a decision whether to accept a transaction requiring the dispensing of change from banknotes stored in the banknote accumulators. This decision includes an assessment of the ability to accept future transactions if the current transaction is accepted. In a different embodiment the operating procedure is associated with a change in the denomination of banknotes being accumulated. This change is assessed, based on the statistical analysis, including an assessment of the operating performance of the current setup and the operating performance of a proposed setup and preferably, an assessment of a decrease in performance during a transition period.

### FIELD OF THE INVENTION

The present invention relates to a currency validator/dispenser where the unit temporarily stores banknotes or other currency received for payment as change in a future transaction.

### BACKGROUND OF THE INVENTION

A banknote validator/dispenser is disclosed in our earlier U.S. Pat. No. 6,371,473 and has a series of three banknote accumulators which cooperate with a banknote dispenser unit for providing the appropriate change for a transaction. Banknotes received for payment are processed by the validator to authenticate the banknotes and a controller in the unit determines whether the received banknotes should be stored for future use. Typically, each of the banknote accumulators stores a single denomination of banknotes.

The currency validator/dispenser of the present application as well as disclosed the banknote validator/dispenser in our earlier patent is in contrast to other systems which do not recycle banknotes provided to the unit during normal transactions to make them available to be returned as change for a future transaction. Some systems allow an operator to basically load the combination validator banknote dispenser with certain banknotes for dispensing as change but these systems do not allow recycling of banknotes between loading operations.

With combination banknote validator/dispenser which allow for recycling of banknotes the normal accepted practice is for an operator to assign each banknote accumulator such that it accumulates a single denomination of banknotes. The control system for the unit monitors each of the accumulators and monitors the received banknotes and appropriately directs banknotes received for payment of a transaction and determines whether any of these banknotes should be stored in any of the accumulators for future dispensing. The control system will know the capacity of each of the accumulators and appropriately make decisions with respect to the storage of the banknotes. It is also possible for this control system to recognize that although a certain banknote has been authenticated the quality of the banknote may be somewhat questionable and determined not to be appropriate for accumulation. These banknotes are directed to a banknote cassette or other storage unit and such banknotes are not available for recycling.

Similarly if a banknote is received that is not of a denomination that is being accumulated it is directed to the banknote cassette. Banknote validator/dispensers with a number of accumulators have the advantage of being capable of accepting payment for more transactions due to the banknotes accumulated from payments and available for dispensing as change. These units cannot accept payment based on inputted banknotes if the unit is not capable of providing the appropriate banknote change to the user. The probability of being able to provide the appropriate banknote change increases with the number of accumulators present.

It has been found that different banknote accumulators experience different conditions and it is difficult for operators to predict the most appropriate banknote value allocations for the banknote accumulators. Furthermore, it is difficult for an operator to predict whether any change in the allocation would improve the performance of the unit.

The present invention seeks to improve the performance of banknote validator/dispensers by more effective control of the accumulators of such units. This improved performance is also applicable to coin changers where different values of coins are stored and/or rejected. Therefore, although the theory of operation is described with respect to banknotes and the assignment of the denomination of banknotes to be stored, it is equally applicable to coin changers and the determination of denominations of coins to be stored and adjusted based on the actual experience. This application has particular application where the currency has some coins of significantly higher value. The system can be used for varying the accumulated denominations of a combination of coins and banknotes.

### SUMMARY OF THE PRESENT INVENTION

A currency validator/dispenser machine according to the present invention comprises a currency validator for receiving currency for payment, at least two currency accumulators cooperating with said validator and temporarily receiving and storing currency for dispensing as change for transactions, a currency dispenser operatively connected to each banknote accumulator to dispense currency provided thereto by said currency accumulators, a computer control module for storing currency receipt and dispensing transaction history information and using said history information for statistical analysis and model forecasting, each currency accumulator having an assignable currency denomination that determines the denomination of currency to be accumulated therein, the computer control module analyzing said transaction history information and based on the analysis reassigned the assignable currency denomination of at least some of the accumulators in response to the actual transaction history information of the validator/dispenser machine.

According to an aspect of the invention, the currency accumulators are banknote accumulators.

According to an aspect of the invention the at least two currency accumulators are at least 3 banknote accumulators.

In a further aspect of the invention the computer control module includes a forecasting procedure that makes a prediction of the performance of the validator/dispenser machine during a transition period associated with a change in the assigned denomination of the banknote accumulators.

In a further aspect of the invention the predicted performance of the validator during the transition period is a factor used by the validator/dispenser machine to determine whether a change in assigned denomination should occur.

In a different aspect of the invention the at least two banknote accumulator is at least 3 banknote accumulator and the computer control module controls the combination of banknotes to be dispensed as part of a transaction in a manner to maintain the ability of the machine to be capable of dispensing change for future transactions.

In another aspect of the invention the computer control module maintains information regarding the banknotes accumulated in each accumulator and uses this information in determining the combination of banknotes to be dispensed.

In a further aspect of the invention the computer control module also includes logic for rejecting a particular transaction due to a determined reduced capability of the banknote validator/dispenser machine to dispense banknotes necessary for future transactions.

In an aspect of the invention the computer control module includes logic for determining a preferred combination of banknotes to be dispensed for a given transaction based on the actual banknotes accumulated in the accumulators.

Preferably the at least 3 banknote accumulators is at least 4 banknote accumulators.

In a different aspect of the invention the computer control module determines the combination of banknotes to be dispensed in a manner to maintain where possible the accumulators at a target fill level based on the number of banknotes in each accumulator relative to the banknotes maintained in the other accumulators. With this system the target fill level for each accumulator can be set as a ratio relative to the other accumulators. Equal filling of each accumulator for example 1:1:1 for three accumulators or proportional filling for example 2:1:1 can be set. These fill ratio can be set by the operator or can be automatically set by the control module based on analysis of the actual experience.

A banknote validator/dispenser machine according to the present invention comprises a banknote validator for receiving banknotes for payment, at least three banknote accumulators cooperating with the validator and temporarily receiving and storing banknotes for dispensing accumulated banknotes as change for transactions, a banknote dispenser operatively connected to each banknote accumulator to dispense banknotes provided thereto by the banknote accumulators, a computer control module for storing banknote receipt and dispensing transaction history information and using said information for statistical analysis, the computer control module using the statistical analysis for determination of the combination of banknotes to be dispensed as change for said transactions taking into consideration the ability of the validator/dispenser machine to be capable of accepting future transactions.

A banknote validator/dispenser machine in a preferred aspect of uses the computer control module to control the operation of the banknote accumulators based on the actual banknote transaction history of the validator/dispenser machine and includes a forecasting model of future performance of the machine.

In an aspect of the invention each banknote accumulator has an assignable denomination of banknote for accumulation and the assigned denomination is controlled by the computer control modules, the computer control module uses the forecasting model to determine whether a different assignment of assigned denominations of the accumulators is predicted to significantly improve the performance of the banknote validator/dispenser machine and changes the assigned denominations when significant improved performance is predicted.

In a different aspect of the invention the computer control module includes a transition procedure for controlling operation of the accumulators during a transition period required to change assigned banknote denominations.

In a further aspect of the invention the computer control module uses the transaction history information to vary the transition procedure.

### BRIEF DESCRIPTION OF THE DRAWINGS

The above as well as other advantages and features of the present invention will be described in greater detail according to the preferred embodiments of the present invention in which;

FIG. 1 is perspective view of a banknote validator/dispenser;

FIG. 2 is a sectional view through a banknote validator/dispenser showing the various parts thereof;

FIG. 3 is a schematic view of a banknote validator/dispenser; and

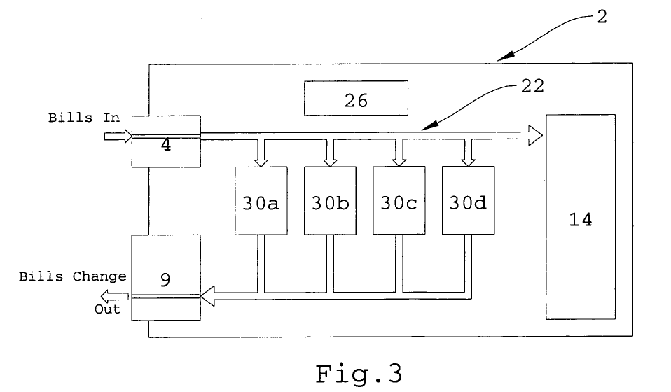

FIG. 4 is a schematic view showing details of the operation and control of the banknote accumulators.

### DETAILED DESCRIPTION ACCORDING TO THE PREFERRED EMBODIMENTS OF THE PRESENT INVENTION IN WHICH

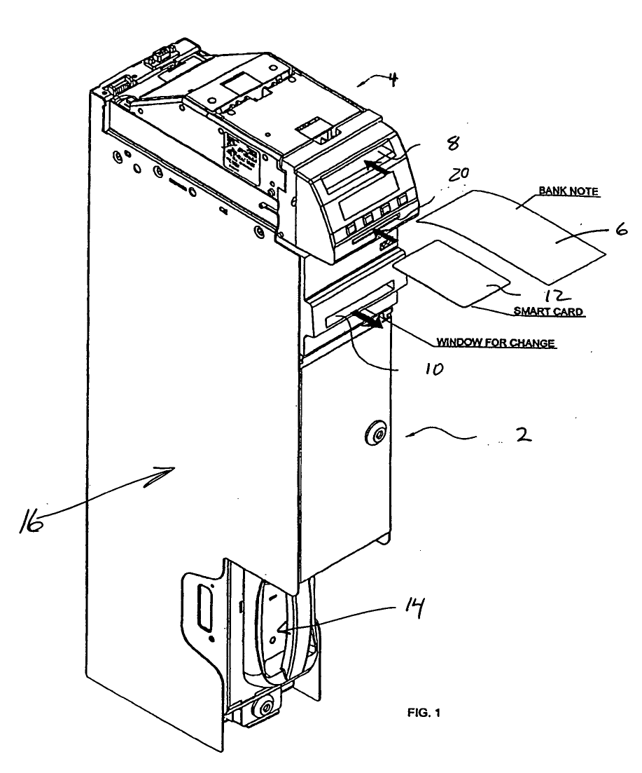

The banknote validator/dispenser 2 shown in FIG. 1 includes a validator 4 which receives banknotes 6 through the input slot 8 of the bezel of the validator. Any banknote change with a particular transaction is provided to the user through the banknote dispensing slot 10. A smart card capability can be provided to the validator for and the validator 4 shown does include a smart card receiving slot 20 for receiving of a smart card 12.

The banknote validator/dispenser 2 includes a number of different components which are received and maintained within the housing 16. One such component is the removable locked banknote cassette 14. This locked bank cassette receives banknotes which the banknote validator/dispenser has determined are not necessary or are not appropriate for the temporary storage for recycling.

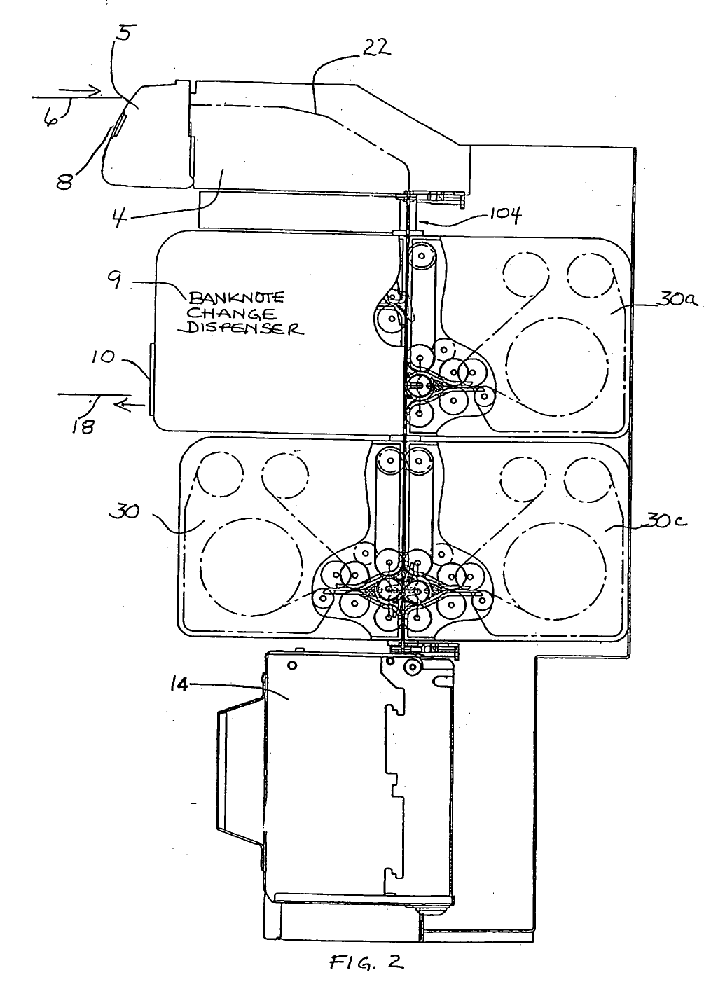

Some additional details of the banknote validator/dispenser are shown in FIG. 2. Banknote 6 are provided to the validator 4 through the input slot 8 and each banknote is individually processed along the banknote path 22 to determine whether the banknote is authentic and should be accepted for payment. If the banknote is acceptable the validator 4 includes logic for determining whether the banknote is appropriate for temporary storage in any of the three banknote accumulators 30a, 30b and 30c. Typically, each of these banknote accumulators will accumulate a single denomination of banknotes. The banknote validator/dispenser does include the ability to change the denomination of the banknotes that are stored if the circumstances so dictate. Any banknotes temporarily stored in any of the banknote accumulators can be provided to the banknote dispenser 10 and provided to the user through the banknote dispensing slot 10. A series of banknotes 18 are shown in FIG. 2 to represent banknotes provided to a user as banknote change for a particular transaction.

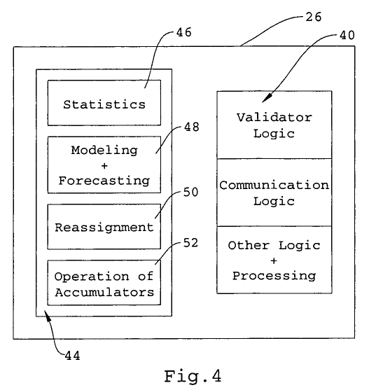

The banknote validator/dispenser depending upon its particular application and other factors will be provided with numerous banknotes 6 over time which are provided to the unit for payment of a particular transaction. These provided banknotes are reviewed by the combination unit to determine whether they are appropriate for temporary storage in any of the accumulators. As in any cash register type system, the unit needs a certain float to be able to provide appropriate banknote change. In stand-alone unmanned applications a transaction cannot be completed if the unit is not capable of providing the appropriate banknote change. The banknote validator/dispenser includes a logic controller 26 shown in FIG. 4 for controlling the operation of the validator/dispenser. The logic controller does include processing logic and hardware 40 including validator logic, communication logic which is necessary for smart card or credit card payment and other logic for the normal operation of the validator/dispenser. In addition, the unit is provided with the capability 44 for operating banknote flow statistic and analysis. This includes statistics 46 which would include the actual experience of the validator/dispenser regarding the banknote provided to it over a certain period of time as part of the payment transaction. This banknote in flow is an important factor in determining the ability of the banknote validator/dispenser to be able to temporally store banknotes for recycling. In addition, statistics are maintained over time with respect to actual banknote change information including the actual banknotes provided as change and the amount of change provided. This information in combination with the present assigned denomination values of each of the accumulators 30a, 30b and 30c are used as part of the statistical analysis under the modeling and forecasting 48 of FIG. 4. The validator/dispenser reviews the present assigned model i.e., the number of denominations being maintained by the accumulators in combination with the actual experience regarding the banknote input and banknote output and can provide an evaluation whether this assignment is appropriate. In addition, this modeling is used to assist in the actual banknote provided as change. For example, the present banknote validator/dispenser with the three accumulators accumulated one dollar bills; five dollar bills and ten dollar bills, a decision has be rendered in providing banknote transaction change for a value of twelve dollars. It would be possible to provide twelve ones or two fives and two ones or two ones and one ten. The actual history of the validator/dispenser i.e., its actual experience with the banknote input and banknote output together with the state of the individual accumulators allows the validator/dispenser to dispense the most appropriate combination. A general principle used by the combination validator/dispenser is to maintain each of the accumulators generally half full. This provides capacity to receive additional banknotes as well as the capability of providing banknote change for most transactions. It is apparent that it is desirable that the banknote validator/dispenser be capable of providing banknote change for most transaction. Decisions may also have to be made whether a particular transaction should be completed. The modeling allows the unit to determine whether it is preferred to reject a particular transaction requiring a significant banknote change which would further reduce the capability of the device to conduct more normal transactions. Thus the statistical information in combination with the modeling forecasting allows the validator/dispenser to determine the appropriate change to be provided i.e., the particular banknotes to be returned.

The modeling and forecasting of the banknote validator/dispenser additionally includes a review of the assigned denominations of the banknote accumulators. It is also allows the assigned values to be reassigned to different values which have been determined to be more appropriate. The validator/dispenser includes the ability of the unit to empty a particular accumulator if necessary by merely directing any further banknotes remaining in the accumulator to the banknote cassette. Once emptied the accumulator can be assigned a different value of banknotes to be accumulated and returned to its normal operation. It is further possible merely to leave the view banknotes remaining in the accumulator in the accumulator and reassign the denomination value. The logic keeps track of the positional point and thus can load new banknotes of the second denomination into the accumulator for recycling. These accumulators store banknotes on the principle of first and last out and as such the unit merely needs to keep track of the change point. It is preferred that the accumulator be emptied as discussed above.

A further description of the operation of the software in general terms with respect to the denomination assignment of the accumulators is provided below. This general description is helpful as different currencies have different denominations and interactions.

1. Optimal banknote accumulator assignment algorithm Problem definition: from the existing set of denominations N to choose the necessary M with the requirement to give the change in the amount of necessary banknote accumulators, and to maintain the ability to dispense change from a critically necessary banknote accumulator.

The objective is the search of the optimal solution with two restrictions:
provide the necessary change volume by keeping the fixed number of banknotes;
provide the discreteness of the required change (the possibility of going out any change).

If we can remove one of these restrictions it eliminates the necessary of optimization. In general the task is the multicriterion problem of discrete programming in following posedness: minimized criterion functions
min xⱼ, where j=the number of banknote accumulators (1.1)
with the following restrictions
•aⱼxᵢⱼ=bᵢ (all change should be given out) (1.2)
•xᵢⱼ<=kᵢ (the number of banknotes in one given change is no bigger than •) (1.3)
•xᵢⱼ<=nⱼ (the number of j-denomination banknotes, that were given out as a change, should not be more than the number of available banknotes in the banknote accumulator, i.e. existing ones plus entered banknotes) (1.4)
xᵢⱼ>=0; xᵢⱼ•Z; (the positivity and integral restrictions), (1.5)
where aⱼ—banknote denomination that is designated for j-banknote accumulator; kᵢ—the maximum amount of banknotes in change set; bᵢ—amount of i-change (here, for example, two occurrences of dispensing $13 change we suppose as different i).

In restriction 1.4 the meaning of nⱼ can be defined by the desired result. For example, to issue from the strategy of giving the change out (in proportion with amount of incoming currency or keeping the level of given out amount on a certain level), this amount can be calculated ad interim. The Gomory method is usually applied to resolve this task. However, if the number of change transactions is more than 500-1000, the task solution demand computational capability (running time, computational burden) more than is. Taking into account, that aⱼ is some fixed series, it's possible simplify the task by using the peculiarity of the series. In particular, if for all aⱼ the aⱼ=n*aₖ is applied, where n is arbitrary integer, then any change can be present as uniquely expansion in terms of assigned accumulator denomination basis.

Definition 1. Under unequivocal we shall understand factorization, at which some representation of number (change) on the set basis and the representation of the same number, which is consecutive factorization of his basic component on the same basis, give unequivocal result.

Definition 2. Basis, when all the numbers from the finite set have uniquely factorization, is the simple basis, otherwise—we have the composed basis.

If the nominal series is simple basis then the solution of the task goes by the following algorithm:
1. Factorize the available change with the maximum number of high denomination bills.
2. If the required number of high denominations is higher then initial, then this discrepancy is factorized on lower basis element.

The cycle continues up to the bill with the smallest denomination. The reserve of bill with the smallest denomination is the indicator of stability of the system. If after the algorithm is finished there is not enough bill of small nomination, then the system will stop after the certain number of transactions. In case the denomination series is the composed basis, which gives a finite set of certain change factorization, uses the algorithm 2:
1. Present the initial basis as the set of a simple basis, which is its subset.
2. Factorize the available change by one of the available basis, which is presented in section 1 (according to algorithm 1). If the solution is not acceptable, it means that there is no possibility to provide the necessary change we jump on step 3.
3. Form the residual vector for all the elements of the basis. Will consider the discrepancy as negative if the number of the necessary denomination is more than the existing one, and positive in the opposite way.
4. Factorize the part of available change by other basis, that was received from the section 1, and will find the minimum residual vector.

As in algorithm 1, the reserve of smallest bill denomination is the indicator of the system's stability. Implementation of step 4 of the following algorithm is the independent task, which can be solved by any of the available methods of discrete programming, for example by the method of recession vector.

As the example we will use the following combination: the denomination series is 1, 2, 5, 10, 20, 50, 100, 200, 500. The following denomination series is composed of two simple series: 1, 5, 10, 50, 100, 500 and 1, 2, 10, 200.

At the same time the ambiguous factorization is possible only for the following change: 6, 8, 10 (if it is not presented in the base), 60, 80, 100 (if is not presented in the base). At that the factorization of 8 and 80 as 2+6 (20+60) remove an ambiguity.

By entering the necessary corrections to the algorithm 1 for additional analysis of the best factorization change for the above-mentioned exceptions (6=5+1 or 6=2+2+2; 10=5+5 or 10=2+2+2+2+2 and the same way with higher denomination), we receive the necessary algorithm.

2. The algorithm of the forming optimal change. Problem definition: Forming change from available denomination in accumulator under constraints:

the number of the banknotes given out should not be bigger than k;
the relation of the remaining number of banknotes in the banknote accumulator should be very close to the mⱼ (the restriction for the change strategy).
   In general the current task is the task of discrete programming in following setting:
   min|(nⱼ−mⱼ)−xⱼ|, where j=number of banknote accumulators (2.1)
   •aⱼxⱼ=b (change should be given out) (2.2)
   •xⱼ<=k (number of banknote is not higher than k) (2.3)
   •xⱼ<=nⱼ (the number of the banknotes given as a change should not be higher than of the number of available banknotes) (2.4)
   xⱼ>=0; xⱼ•Z; (the positivity and integral restrictions), (2.5)

Let's notice, if we remove the constraint 2.3 than the solution of the task is simplifying and comes to the simple iterative formula:
xⱼ=(Pⱼ−Sⱼ)/Nⱼ, (2.6)
where xⱼ—the number of banknotes for given out from banknote accumulator j; Pⱼ—amount of many in accumulator from smaller denomination to j; Sⱼ—change, stayed for given out on step j; Nⱼ—denomination of bank note in accumulator j.
yⱼ=Sⱼ−k*Nⱼ′/Nⱼ′, (2.7)
where Nⱼ′=Pⱼ/Zⱼ, Zⱼ—the number of banknotes in banknote accumulator from smaller denomination to j; As a result the algorithm of the problem decision becomes:
1. Define, according to formula (2.6), the preferable number of high denomination banknotes for the change (2.6).
2. Define, according to formula (2.7), the minimally allowable number of high denomination banknotes for the change.
3. If xⱼ>yⱼ, then give out the xⱼ banknotes as a change, otherwise—yⱼ.
4. If the number of available banknotes in the banknote accumulator is smaller than yⱼ the task does not have a solution, otherwise decrease the change on amount given from banknote accumulator j. Now the next denomination consider as the major.
5. If j denomination is not the smallest, then proceed to step 1, otherwise finish the calculation.

The above description and explanation assumes the general principle to optimize the operation of the validator/dispenser machine in order to appreciate the various factors that affect the operation of the machine. Variations from full optimization still allow effective operation and are included as part of the present invention.

With the present system the banknote validator/dispenser is able to respond to its actual experience and make appropriate adjustments in the storage of banknotes for recycling to satisfy initially the anticipated needs of the unit and in time based on the actual needs of the unit. An initial assignment of the banknote accumulators is provided however over time the actual experience of the validator/dispenser is used to make appropriate adjustments and to have this information available for further analysis if it is deemed appropriate. In the preferred embodiment, the banknote validator/dispenser reviews the actual performance thereof and makes appropriate changes when it is deemed necessary. It is also possible that an operator makes such a final determination based on a recommendation from the banknote validator/dispenser. For example, operators are attending at these units for emptying of full banknote accumulators or perhaps providing banknotes to the unit for accumulation for banknote change on a daily, weekly or other basis. It is possible that the banknote validator/dispenser merely provides notice to such an operator that based on its actual experience a change in the banknote accumulator assignment (denomination being accumulated) should be made to the operator can then determine whether this step should be implemented.

With respect to the statistical information maintained the smart card reader can also include the capability of exporting the statistical information and transaction information to an operator. This can be taken for authentication purposes modeling purposes or as a test evaluation of a generally proposed banknote accumulator reassignment.

The invention has been described with respect to accumulating banknotes, however, the process also applies to accumulating coins for later dispensing as change. Various arrangements are known for accumulating coins in coin tubes which can include the automatic placement of the appropriately sized coin tube. Therefore, the system for tracking and improving performance applies to any currency type, including coins.

Also, this technology can be used to recommend changes in currency type accumulated and/or available for dispensing to improve the performance. Recycling of the currency types is not always required.

Although various preferred embodiments of the present invention have been described in detail, it will be appreciated by those skilled in the art that variations may be made without departing from the spirit of the invention or the scope of the appended claims.

The embodiments of the invention in which an exclusive property or privilege is claimed are defined as follows:

1. A currency validator/dispenser comprising a currency validator for receiving currency for payment, a plurality of currency accumulators cooperating with said validator and temporarily receiving and storing currency for dispensing as change for transactions, a currency dispenser operatively connected to each currency accumulator to dispense currency provided thereto by said currency accumulators, a computer control module for storing banknote receipt and dispensing transaction history information and using said information for statistical analysis and model forecasting, said currency validator including at least one variable operating function that alters the operating procedure of said currency validator/dispenser; said computer control module analyzing said transaction history information and based on said analysis automatically altering said at least one variable operating function in response to the actual transaction history information of the validator/dispenser machine to automatically improve the operation thereof.

2. A currency validator/dispenser as claimed in claim 1 wherein said plurality of currency accumulators are banknote accumulators with each banknote accumulator having an assignable banknote denomination value that determines the denomination of banknotes to be accumulated therein and said at least one variable operating function determines the assigned denomination value for each banknote accumulator; said computer control module analyzing said transaction history information and based on said analysis reassigns the assignable banknote denomination value of at least some of said accumulators in response to the actual transaction history information of the validator/dispenser.

3. A currency validator/dispenser as claimed in claim 2 wherein said at least two banknote accumulators are at least three banknote accumulators and said at least one variable operating function includes the decision to change the assigned banknote denomination values of said banknote accumulators, said computer control module using said transaction history information to forecast whether a change in the assigned banknote denomination value should be completed at a given point in time based on a forecast of reduced availability during transition to the new assigned banknote denomination values.

4. A currency validator/dispenser as claimed in claim 1 wherein said at least one variable operating function includes logic used to determine the combination of currency to be dispensed as change for a particular transaction, said computer control module using said statistical analysis for determination of the combination of currency to be dispensed as change in combination with statistical forecasting of the ability of said validator/dispenser machine to be capable of accepting future transactions.

5. A currency validator/dispenser as claimed in claim 4 wherein the logic used to determine the combination of banknotes to be dispensed as change for a particular transaction includes analysis of the subsequent ability to dispense change for future transactions and including the capability to refuse a transaction requiring change if said subsequent ability to dispense change is decreased in an unacceptable manner.

6. A currency validator/dispenser as claimed in claim 2 wherein said at least one variable operating function includes logic used to determine if a transaction requiring dispensing of change is to be accepted, said logic including determination of the number of banknotes in each accumulator and the number of banknotes remaining in each accumulator, if the transaction is accepted.

7. A currency validator/dispenser as claimed in claim 6 wherein said logic uses the number of banknotes remaining in each accumulator to assess the ability to accept future transactions and rejecting certain transactions where the assessed ability to accept future transactions is disproportionally reduced.

8. A banknote validator/dispenser machine comprising a banknote validator for receiving banknotes for payment, at least two banknote accumulators cooperating with said validator and temporarily receiving and storing banknotes for dispensing as change for transactions, a banknote dispenser operatively connected to each banknote accumulator to dispense banknotes provided thereto by said banknote accumulators, a computer control module for storing banknote receipt and dispensing transaction history information and using said information for statistical analysis and model forecasting, each banknote accumulator having an assignable banknote denomination that determines the denomination of banknotes to be accumulated therein, said computer control module analyzing said transaction history information and based on said analysis reassigns the assignable banknote denomination of at least some of said banknote accumulators in response to the actual transaction history information of the validator/dispenser machine.

9. A banknote validator/dispenser machine as claimed in claim 8 wherein said at least two banknote accumulators is at least 3 banknote accumulators.

10. A banknote validator/dispenser machine as claimed in claim 9 wherein said computer control module includes a forecasting procedure that makes a prediction of the performance of the validator/dispenser machine during a transition period associated with a change in the assigned denomination of said banknote accumulators.

11. A banknote validator/dispenser as claimed in claim 10 wherein the predicted performance of the validator during the transition period is a factor used by the validator/dispenser machine to determine whether a change in assigned denomination should occur.

12. A banknote validator/dispenser machine as claimed in claim 8 wherein said at least two banknote accumulator is at least 3 banknote accumulators and said computer control module controls the combination of banknotes to be dispensed as part of a transaction in a manner to maintain the ability of the machine to be capable of dispensing change for future transactions.

13. A banknote/validator/dispenser machine as claimed in claim 12 wherein said computer control module maintains information regarding the banknotes accumulated in each accumulator and uses this information in determining the combination of banknotes to be dispensed.

14. A banknote validator/dispenser machine as claimed in claim 12 wherein said computer control module also includes logic for rejecting a particular transaction due to a determined reduced capability of said banknote validator/dispenser machine to dispense banknotes necessary for future transactions.

15. A banknote validator/dispenser machine as claimed in claim 9 wherein said computer control module includes logic for determining a preferred combination of banknotes to be dispensed for a given transaction based on the actual banknotes accumulated in said accumulators.

16. A banknote validator/dispenser as claimed in claim 9 wherein said at least 3 banknote accumulators is at least 4 banknote accumulators.

17. A banknote validator/dispenser as claimed in claim 16 wherein said computer control module determines the combination of banknotes to be dispensed in a manner to where possible maintain the number of banknotes in each accumulator in a desired ratio relative to the number of banknotes maintained in the other accumulators.

18. A banknote validator/dispenser machine comprising a banknote validator for receiving banknotes for payment, at least three banknote accumulators cooperating with said validator and temporarily receiving and storing banknotes for dispensing accumulated banknotes as change for transactions, a banknote dispenser operatively connected to each banknote accumulator to dispense banknotes provided thereto by said banknote accumulators, a computer control module for storing banknote receipt and dispensing transaction history information and using said information for statistical analysis, said computer control module using said statistical analysis for determination of the combination of banknotes to be dispensed as change for a current transaction.

19. A banknote validator/dispenser machine as claimed in claim 18 wherein each banknote accumulator has an assignable denomination of banknote for accumulation and the assigned denomination is controlled by said computer control module, said computer control module using a forecasting model to determine whether a different assignment of assigned denominations of said accumulators is predicted to significantly improve the performance of said banknote validator/dispenser machine and changing said assigned denominations when significant improved performance is predicted.

20. A banknote validator/dispenser machine as claimed in claim 19 wherein said computer control module includes a transition procedure for controlling operation of said accumulators during a transition period required to change assigned banknote denominations.
